(19) United States
(12) Patent Application Publication
(10) Pub. No.: US 2025/0190974 A1
(43) Pub. Date: Jun. 12, 2025

(54) DISPLAYING MESSAGE STATUS FOR A BLOCKCHAIN MESSAGE

(71) Applicant: Coinbase, Inc., Oakland, CA (US)

(72) Inventors: Jihoon Suh, New York City, NY (US); Axel-Konstantin Marko, Los Angeles, CA (US); Sina Deyhim, Ottawa (CA); Victor Frolov, Los Angeles, CA (US); Colin Johnson, Redondo Beach, CA (US); Valentin Shergin, Austin, TX (US)

(21) Appl. No.: 18/531,595

(22) Filed: Dec. 6, 2023

(51) Int. Cl. G06Q 20/36; H04L 51/48

(52) U.S. Cl. CPC G06Q 20/36; H04L 51/48; G06Q 2220/00

(57) ABSTRACT

Methods, systems, and devices for displaying message status for a blockchain message are described. A client application may display, at a first position in a navigation banner of a client application, an address indicator of a wallet address associated with the client application. The client application may be configured to navigate to a crypto token summary page after activation of the address indicator in the navigation banner. The client application receives information that indicates that a message associated with the wallet address is submitted for broadcast. The client application displays, after receiving the information and at the first position in the navigation banner, a pending indicator that indicates that the message is pending confirmation via the blockchain network. The client application may be configured to navigate to a message information page after activation of the pending indicator in the navigation banner. The pending indicator replaces the address indicator.

### FIELD OF TECHNOLOGY

The present disclosure relates generally to data management, including techniques for displaying message status for a blockchain message.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports displaying message status for a blockchain message in accordance with aspects of the present disclosure.

FIG. 2 shows an example of a computing environment that supports displaying message status for a blockchain message in accordance with aspects of the present disclosure.

FIG. 3 shows an example of a signing procedure that supports displaying message status for a blockchain message in accordance with aspects of the present disclosure.

FIG. 4 shows an example of a pending transaction that supports displaying message status for a blockchain message in accordance with aspects of the present disclosure.

FIG. 5 shows an example of a status notification that supports displaying message status for a blockchain message in accordance with aspects of the present disclosure.

FIG. 6 shows an example of a process flow that supports displaying message status for a blockchain message in accordance with aspects of the present disclosure.

FIG. 7 shows a block diagram of an apparatus that supports displaying message status for a blockchain message in accordance with aspects of the present disclosure.

FIG. 8 shows a block diagram of a client application that supports displaying message status for a blockchain message in accordance with aspects of the present disclosure.

FIG. 9 shows a diagram of a system including a device that supports displaying message status for a blockchain message in accordance with aspects of the present disclosure.

FIGS. 10 through 12 show flowcharts illustrating methods that support displaying message status for a blockchain message in accordance with aspects of the present disclosure.

### DETAILED DESCRIPTION

A user may access a custodial token platform to purchase, sell, exchange, or trade digital assets, such as cryptocurrencies, crypto tokens, or the like. A custodial token platform may support various types of wallets for deposits, withdrawals, and storage. For example, the custodial token platform may generate inbound wallets associated with inbound addresses for user deposits of crypto tokens to accounts associated with the user. The custodial token platform may also use outbound wallets for supporting withdrawals of crypto tokens and cold storage wallets for security. In some cases, the user may manage and use a self-custody wallet, and the user may access features or services supported by a blockchain network via the self-custody wallet. In some cases, such as when a user purchases, sells, exchanges, or otherwise performs a transaction related to the crypto tokens, the user may monitor the status of the transaction. For example, a user my purchase a non-fungible token (NFT) using crypto tokens, for example, in a client application (e.g., custodial token platform application or a self-custody wallet application) associated with the custodial token platform or separate from the custodial token platform. However, the client application may not provide details or the status of the transaction. As such, the user may be unaware of whether the transaction was successful (e.g., verified on the blockchain network), whether the crypto tokens were accepted, whether the transaction is pending, and may be unaware of other transaction-related details. In some cases, the user may access some details related to the transaction using a multiple-step process (e.g., multiple clicks) in the client application. The multiple steps may be time consuming and inefficient, and in some cases, may not provide the details that the user may prefer to view.

Techniques described herein address these difficulties by providing a technique for subscribing to the transaction (e.g., a message), tracking data associated with the transaction at each stage of the transaction, and displaying the status of the transaction in the client application. The client application subscribing to the transaction may allow the associated client application to provide a current and thorough view of the transaction. For example, the client application may display a real-time status of the transaction (e.g., paid amount of crypto tokens for the transaction, completion or intermediate status of transaction (e.g., transaction submitted or transaction in progress), estimated duration left until completion of transaction, etc.). In this manner, a user may review transaction details, as well as perform actions to ensure successful completion of the transaction. Additionally, subscribing to a transaction may facilitate in providing detailed notifications to the user (e.g., via the client application or a user device associated with the user), improving user experience with the client application and transaction process. As used herein, the term “subscription” refers to a relay mechanism that accesses a data stream for a specific event to provide live or real-time updates (e.g., status). For example, each time a transaction is submitted, a subscription may be initiated, and the stream of data from the subscription to the related data may be used to provide real-time data to display at the client application (e.g., update a user interface of the client application with the status of the transaction). These and other techniques are described in further detail with respect to the figures.

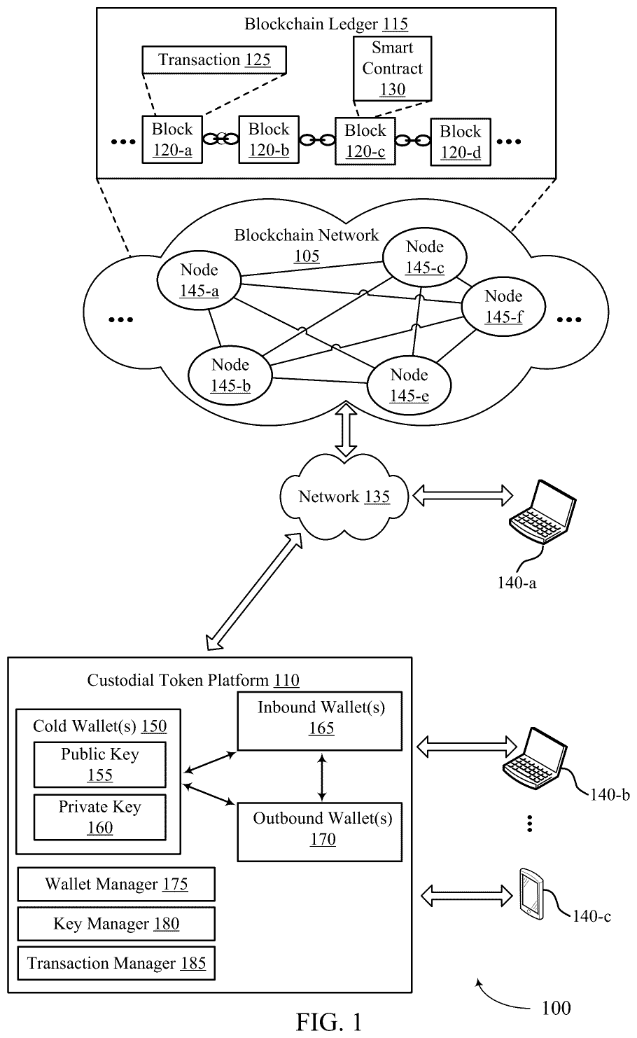

FIG. 1 illustrates an example of a computing environment 100 that supports displaying message status for a blockchain message in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a subprogram that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens from a wallet managed by the custodial token platform 110 to an external wallet, to deploy a smart contract (e.g., a self-executing program), or to call a smart contract.

Additionally, a user may access the services or features supported by the blockchain network 105 via a client application, such as an application configured to access the custodial token platform 110 or another wallet application. The user may access the application to purchase, sell, exchange, or trade digital assets, such as cryptocurrencies, crypto tokens, or the like or to access Web3 services such as services supported by one or more smart contracts (e.g., smart contract 130), token gated services, DeFi services or the like. When a user purchases, sells, exchanges, or otherwise performs a transaction related to the crypto tokens or smart contracts, the user may monitor the status of the transaction. For example, a user may purchase an NFT using crypto tokens, for example, in a client application associated with the custodial token platform 110. However, the client application may not provide details or the status of the transaction, and thus, the user of the client application may be unaware of the status of the transaction. The user may also access some details related to the transaction using a multiple-step process (e.g., multiple clicks) in the custodial token platform application, but the multiple steps may be time consuming and inefficient for determining status of the transaction.

Techniques described herein address these difficulties by providing a technique for subscribing to the transaction (e.g., a message) and tracking data associated with the transaction at each stage of the transaction. For example, a client application may display, at a first position in a navigation banner of a client application, an address indicator of a wallet address associated with the client application (e.g., a wallet that is connected to or otherwise accessible by the client application). When the user submits or otherwise activates a transaction via the application (e.g., by interacting with a Web3 interface), tracking may involve receiving, at the client application, information that indicates that a transaction (e.g., the message) is associated with the wallet address is submitted for broadcast via a blockchain network. More particularly, after the user submits the transaction (e.g., signs the message), and the message is broadcast (or transmitted for broadcast), the client application may determine that the transaction is submitted for broadcast. Tracking may involve displaying, after receiving the information and at the first position in the navigation banner, a pending indicator that indicates that the transaction is pending confirmation via the blockchain network, where the client application may navigate to a transaction information page after activation of the pending indicator in the navigation banner. In such examples, the pending indicator may replace the address indicator. Thus, after the message is submitted, the client application may replace the wallet address indicator with a pending indicator that indicates that the transaction is pending via the blockchain network. Activation of the wallet address indicator may cause the client application to navigate to a token summary page, and activation of the pending indicator that replaces the wallet address indicator (after the message is submitted for broadcast) may cause the client application to navigate to a message information page that displays details associated with the message.

The client application subscribing to the transaction may allow the associated client application to provide a current and thorough view of the transaction. For example, the client application may display a real-time status of the transaction (e.g., paid amount of crypto tokens for the transaction, completion or intermediate status of transaction (e.g., transaction submitted or transaction in progress), estimated duration left until completion of transaction, etc.). In this manner, a user may review transaction details, as well as perform actions to ensure successful completion of the transaction. Additionally, subscribing to a transaction may facilitate in providing detailed notifications to the user (e.g., via the client application or a user device associated with the user), improving user experience with the client application and transaction process. As used herein, the term “subscription” refers to a relay mechanism that accesses a data stream for a specific event to provide live or real-time updates (e.g., status). For example, each time a transaction is submitted, a subscription may be initiated, and the stream of data from the subscription to the related data may be used to provide real-time data to display at the client application (e.g., update a user interface of the client application with the status of the transaction). These and other techniques are described in further detail with respect to the figures.

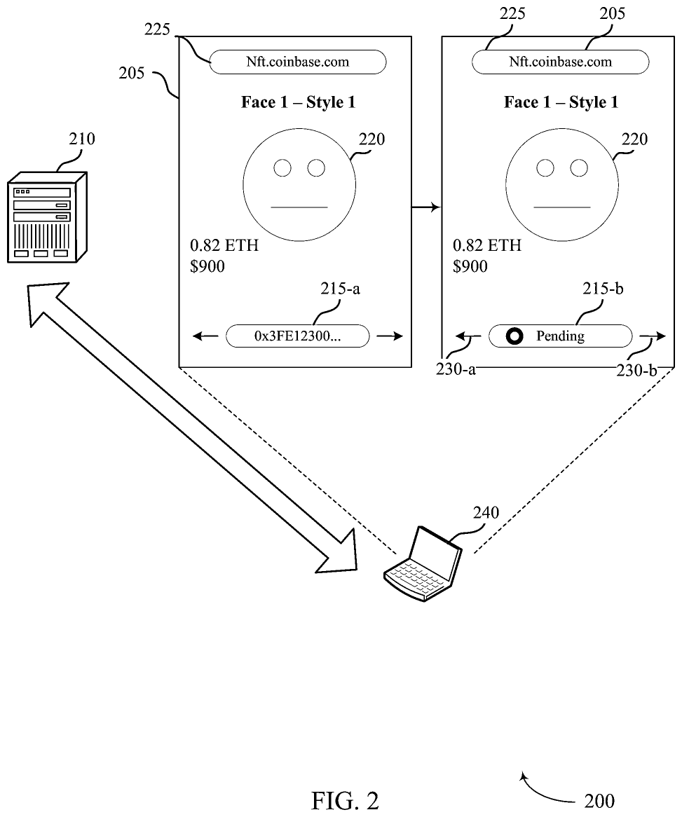

FIG. 2 shows an example of a computing environment 200 that supports displaying message status for a blockchain message in accordance with aspects of the present disclosure. The computing environment 200 includes one or more servers 210, a client application 205, and a user device 240 that is associated with the client application 205. The servers 210 may be an example of one or more servers supporting the custodial token platform 110 as described with respect to FIG. 1 or one or more servers otherwise associated with or accessible by the client application 205, and the user device 240 may be an example of the computing devices 140 as described with respect to FIG. 1. Although the discussions described herein relate to cryptocurrency with respect to crypto tokens, the cryptocurrency may include tokens, coins, digital currency, and the like. Moreover, although the discussions described herein relate to transactions with respect to NFTs, the transactions may include any transactions with varying statuses that are associated with the client application 205 and/or the custodial token platform 110. For example, the transactions may relate to other types of interactions with blockchain networks such as transactions associated with Web3 services (e.g., DeFi services and token gated services).

The servers 210 may support various transactions performed in the client application 205 or as offered by the custodial token platform 110 of FIG. 1. In some examples, the servers 210 may store or access token-related data, as well as support various token-related transactions for various purposes. In some examples, the servers 210 may support subscribing to data associated with a transaction. As part of subscribing procedures, the servers 210 may communicate with the client application 205, the user device 240 (e.g., transmit to or receive from, as indicated by the double-sided arrow), the custodial token platform 110, a blockchain network, and/or other devices or applications that are associated with or accessible by the user or user wallet account of the user. In some examples, the client application 205 may use unique identifiers (UIDs) of transactions and/or chain identifiers (IDs) for tracking pending transactions. In order to access data related to the pending transactions across one or more networks, the client application 205 may connect to or have access to each of the networks (e.g., blockchain networks or associated service) and accounts, and the transactions across the networks may be tracked by subscription. In such examples, subscription may involve fetching data related to the total pending transactions for a user (e.g., refetchPendingTransactions, refreshSubscription, totalPendingTransactions). The client application 205 (or a data feed service supported by the server 210) may request data from the blockchain based on a time interval (e.g., every few seconds) and blockchain may transmit the requested data back to the application 205 (or the server 210) to display an updated status with respect to the transaction.

The user may access a user account associated with the client application 205 via a user interface on the user device 240 such as to enter account information, review crypto token balances, other wallet-related details, etc. In some examples, the user may access the client application 205 to perform a transaction (e.g., sign a message). Additionally, in some examples, the user may connect a wallet via the client application 205 (e.g., that is local to the user device 240) in order to execute such a transaction. For example, the client application, 205 may be a wallet application that is associated with the custodial token platform or separate from the custodial token platform, and the user may manage a self-custody wallet (or multi-party computation (MPC) wallet) and use the client application to interact with blockchain services using the wallet.

As an example, the user may navigate to a service (e.g., Web3 service) using the client application, and the service may support purchasing of an NFT. As the user navigates to the Web3 service, a navigation banner 215-a may display information about the currently active or connected user wallet. As illustrated, the navigation banner 215-a displays, in the navigation banner 215-a, the wallet address for the wallet that is active in the client application 205. If the user activates the navigation banner or the wallet address, then the client application 205 may navigate to a page associated with the wallet (e.g., a page that displays crypto tokens associated with the wallet).

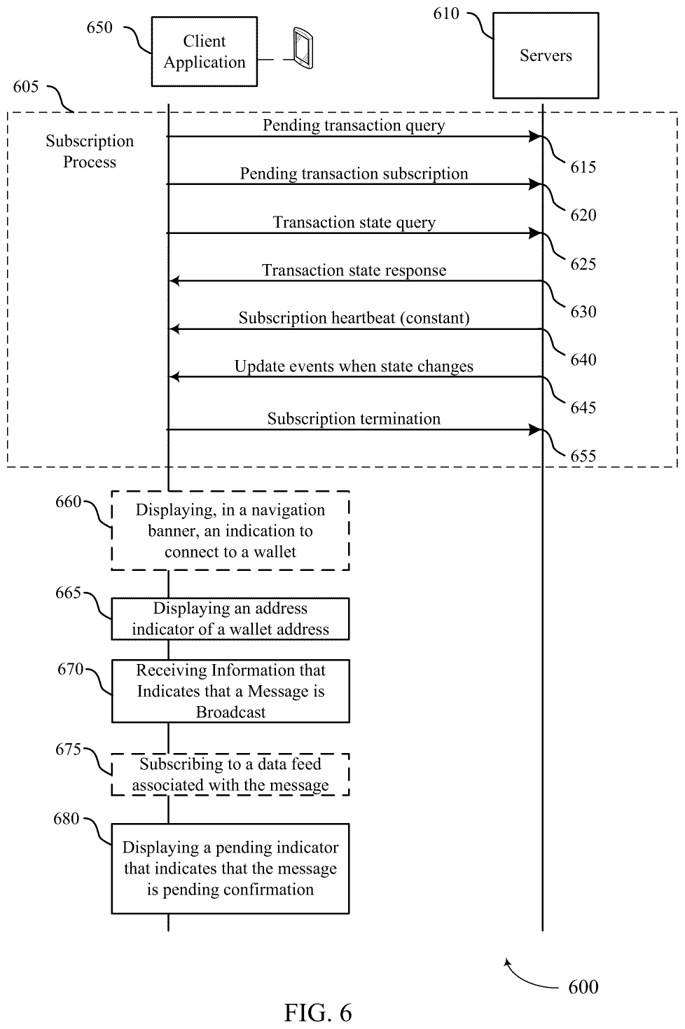

The user may perform a transaction of purchasing an NFT 220 (Face 1-Style 1) in the client application 205. Purchasing of the NFT may include activating a purchase button (or the like), and the client application 205 may display a transaction for the user to sign using the wallet. After the transaction is signed, the client application 205 may broadcast the signed transaction via the blockchain network or otherwise communicate the signed transaction to a backend service (e.g., the server 210) for broadcast via the blockchain network. Additionally, the client application 205 may subscribe to data related to the transaction, as discussed with respect to FIG. 6. After transmitting or confirming the transaction, the navigation banner 215-b may indicate a current status of the transaction, for example, after the submission or request for the transaction (e.g., request to purchase the NFT 220). The status may include at least initiated, submitted, in progress, pending, completed, success, failure, and the like. The status in the navigation banner 215 may change as the subscribed data is updated for the transaction. The user may engage in more than one transaction and thus, the client application 205 may subscribe to the multiple transactions. In some examples, the user may navigate to different pages corresponding to respective transactions, and the navigation banner 215 on the displayed page may correspond to the respective transaction. In other examples, multiple statuses for the multiple transactions may be displayed on a single page, such that the user may navigate through the status in the navigation banner 215 to view the multiple statuses.

Additionally, the navigation banner 215 may display other statuses that may be associated with the transaction, the client application 205, account, the wallet, etc. In such examples, the navigation banner 215 may display a status of at least restricted access, verification, recover limited access, and the like. As illustrated, the navigation banner 215-a may display a wallet address associated with the client application 205 (e.g., for the user). For example, the navigation banner 215 may display the wallet address before or after occurrence of a transaction, such that a transaction associated with the wallet is not pending. If a wallet is not connected to the client application 205, the navigation banner 215 may display an indication to connect or to create a wallet to be associated with the client application 205. The transaction status indicators, the wallet address, the indication to connect or create the wallet, etc., may be displayed in a portion of the navigation banner 215 (e.g., at a first position) or may display across the entire navigation banner 215. In some examples, the navigation banner 215 may display multiple statues for the multiple transactions in different portions (e.g., at different positions) of the navigation banner 215.

The wallet authentication procedure may involve the servers 210 transmitting a message (e.g., authentication request) to a wallet address that is connected to the wallet of the user. For example, the user device 240 may receive the message at a user interface of the user device 240 (e.g., at a client application 205 or wallet application) to sign the message. The user may sign the message, which may be subsequently transmitted to the servers 210 for verification. The servers 210 may return a proof token to the user device 240 if the signature is accepted.

In some examples, the client application 205 may be an example of or may be configured to access (such as via a browser) a decentralized application (dApp), which may include or may be supported by a smart contract that runs on a decentralized computing, blockchain, or other distributed ledger system. The client application 205 may be configured for Web3 and include a web browser display within the application, such that the user interface of the client application 205 displays a first navigation button 230-a (back button) to navigate to a previous page (e.g., web page) and/or a second navigation button 230-b (forward button) to navigate to a subsequent page. In some examples, the navigation buttons 230 may facilitate viewing multiple navigation banners 215 and/or multiple pages. The client application 205 may also include an additional banner 225 that displays a Web3 title or address for the displayed webpage on the client application 205. For example, the additional banner 225 may display the address for a Web3 marketplace for NFTs and crypto collectibles (Nft.coinbase.com), where the transaction for purchasing the NFT 220 is performed. The client application 205 may also display the cost to purchase the NFT 220, such as Ether (ETH) (e.g., 0.82 ETH) and the equivalent in other currencies used to purchase ETH, such as United States dollars (e.g., $900).

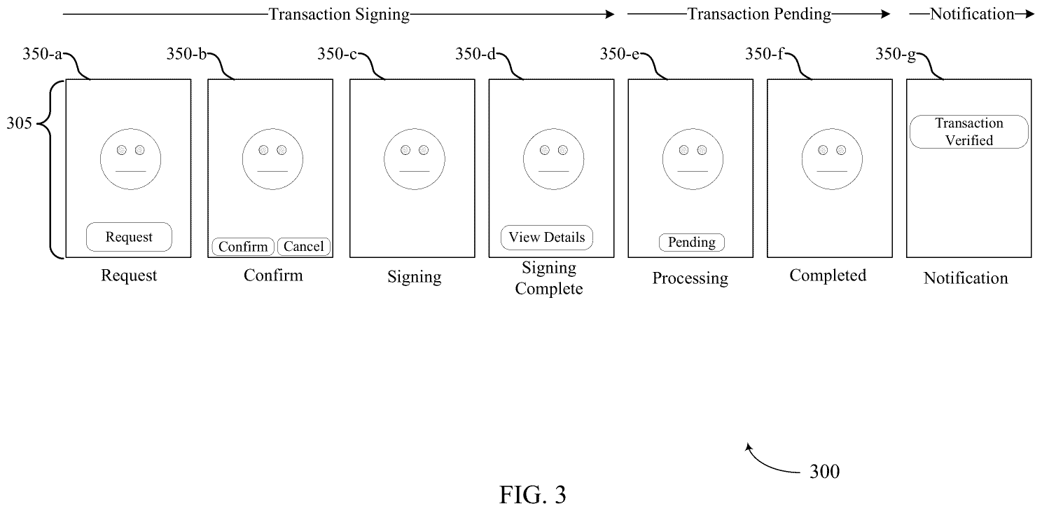

FIG. 3 shows an example of a signing procedure 300 that supports displaying message status for a blockchain message in accordance with aspects of the present disclosure. The signing procedure 300 may be associated with one or more status updates. The client application 305 may subscribe to the data associated with the signing procedure and correspondingly display the one or more status updates on the user interface 350 of the user device that is displaying the client application 305, so that the user may view real-time updates associated with the transaction.

The updates associated with the signing procedure 300 may involve a transaction signing procedure, a transaction pending procedure, and a notification procedure, where the user interface 350 is updated according to updates associated with the signing procedure 300. The indications discussed with respect to the user interface 350 may be in the form of an indication in the navigation banner, new text appearing, a new window or web page opening, displaying of new buttons, or the like. Additionally, or alternatively, the indication may be outside of the client application 305, for example, on a lock screen of the user device, a text message to the user device, an island on the user interface of the user device, and other forms of display to provide an indication of the update to the user.

The transaction signing procedure of the signing procedure 300 may include a user interface 350 displaying a first user interface 350-a that indicates a request for signing a transaction. The transaction may be updated such that the request has been accepted or confirmed, and a second user interface 350-b may display at the user interface 350 of the client application 305. The second user interface 350-b may display an indication of the confirmation. After or in response to confirmation, a third user interface 350-c may display at the user interface 350 of the client application 305, in which the third user interface 350-c may display an indication of the signing (e.g., digital signature). After signing, a fourth user interface 350-d may display at the user interface 350 of the client application 305, in which the fourth user interface 350-d may display an indication of the signing being complete (e.g., digital signature accepted).

Accordingly, the transaction may be pending after the signing has been completed. The transaction pending procedure of the signing procedure 300 may include a fifth user interface 350-e, in which the fifth user interface 350-c may display an indication of the transaction processing (e.g., transaction-related conditions are confirmed or procedures are being performed). A sixth user interface 350-f may display at the user interface 350 of the client application 305, in which the sixth user interface 350-f may display an indication of the processing being completed.

Accordingly, a notification may be sent to the user that indicates that the transaction has been completed. The notification procedure of the signing procedure 300 may include a seventh user interface 350-g, in which the seventh user interface 350-g may display an indication of the transaction being completed. The indicator may be in the form of a notification in the client application 305 and/or at the user device (e.g., lock screen) such as via a push notification. In this manner, the user may view real-time updates of the transaction.

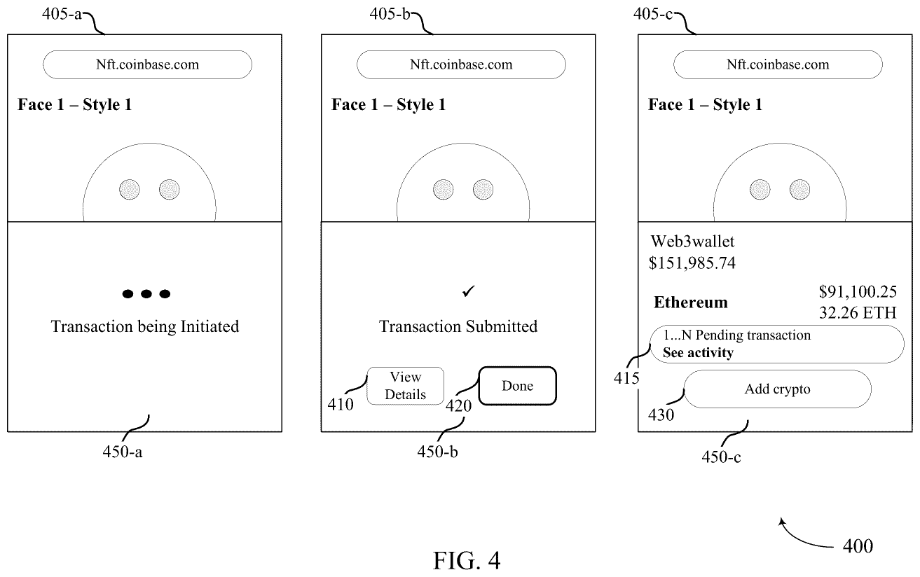

FIG. 4 shows an example of a pending transaction 400 that supports displaying message status for a blockchain message in accordance with aspects of the present disclosure. A user interface 450 of a client application 405 may be updated during the pending transaction 400 and provide an indication accordingly at a user interface 450.

The user interface 450-a of the client application 405-a may display an indication of a transaction being initiated, for example, after a user submits a request for the transaction.

Once the request is accepted, the user interface 450-b of the client application 405-b may display an indication that the transaction has been submitted. That is, the conditions for submitting the transaction have been fulfilled. However, if conditions were not met, such as the wallet not having sufficient funds to perform the transaction, an incorrect destination address, or the occurrence of other non-compliant conditions, the user interface 450-b may display an indication that the transaction failed. In some examples, the user interface 450-b may also include a view detail button 410 and a done button 420, and the selection of a button may be indicated in the user interface 450-b, such as by a button weight or shape change (e.g., bold outline of button), font change, color change, etc. The view detail button 410 may allow the user to view details related to the transaction and the done button 420 may allow closing details related to the transaction.

Once the transaction has been submitted, the user interface 450-c of the client application 405-c may display an indication that the transaction is pending in a navigation banner 415. In some examples, a user may perform N transactions, where N is greater than one, where the user may perform multiple transactions. Accordingly, a first position of the navigation banner 415 may indicate that multiple transactions are pending, and in some examples, a second position of the navigation banner 415 may include a selectable “see activity” option to view activity associated with the one to N transactions.

The user interface 450-a of the client application 405-a may display an indication of a transaction being initiated, for example, after a user submits a request for the transaction. Once the request is accepted, the user interface 450-b of the client application 405-b may display an indication that the transaction has been submitted. The client application 405-c may display the status of the submitted transaction and may include an add crypto button 430 that allows the user to add or purchase additional ETH to the user's wallet, for example, to perform future transactions (e.g., purchase another NFT). Accordingly, the user interface 450-c may display details about the wallet associated with the user, such as the quantity of currencies or assets associated with the wallet (e.g., $151,985 is associated with the Web3 Wallet, 32.26 ETH (equal to $91,100.25) in Ethereum, etc.). Accordingly, using the subscription techniques described herein, the client application 405 may display real-time or live updates at the client application 405 and/or at a user device that are associated with one or more transactions associated with the client application 405 (e.g., the user and/or the digital wallet of the user).

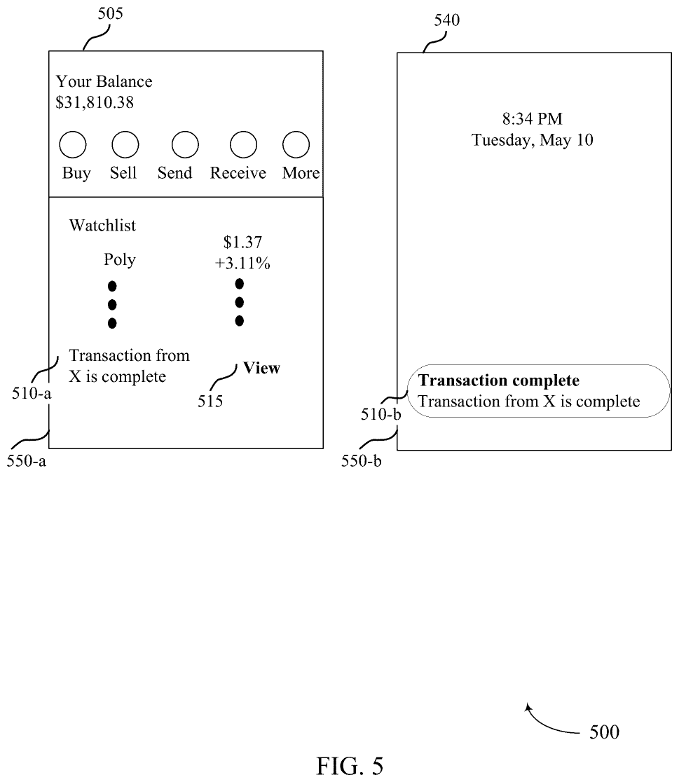

FIG. 5 shows an example of a status notification 500 that supports displaying message status for a blockchain message in accordance with aspects of the present disclosure. The status notification 500 may be displayed at a user interface 550-a of the client application 505 and/or at a user interface 550-b of the user device 550 (e.g., lock screen).

The user interface 550-a of the client application 505 may display a user balance (e.g., “Your balance”), options to perform a transaction (e.g., buy, sell, send, receive, more), as well as a watchlist that includes a list of one or more cryptocurrencies or tokens that the user is interested in tracking (e.g., Poly increased in value by 3.11%). The user interface 550-a may also display a status indication 510-a (e.g., final status) that indicates that a particular transaction (e.g., transaction X) that was previously pending has now been completed. In some examples, the status indication 510-a may be displayed along with a viewing indication 515, which may be selectable and allow the user to view details related to the completed transaction after or in response to selection. The user interface 550-a may display multiple transactions and the corresponding statuses of the transactions. In some cases, the user interface 550-a is accessed or generated if the user activates the pending indicator of the navigation banner, as described herein. For example, activation of the pending indicator may navigate the user to the message information page (e.g., user interface 550-a) that displays either message information for a single transaction or a summary page for multiple transactions.

The user interface 550-b of the user device 540, which may be a lock screen in some examples, may display the status indication 510-b. The status indication 510-b may indicate that the pending transaction (e.g., transaction X) has been completed. In examples where multiple transactions are pending and finishing, the user interface 550-b may display a status indication 510-b for each of the completed transactions. The client application 505 may stop fetching data or performing a live query once the transaction has completed and the status indication 510 is displayed. In some examples, if a transaction has failed rather than successfully completed, the status indication 510 may display an indication accordingly of the failure. In some examples, the status indication 510 may provide details of the failure and/or options to resolve the issue that caused the failure.

FIG. 6 shows an example of a process flow 600 that supports displaying message status for a blockchain message in accordance with aspects of the present disclosure. The process flow 600 includes a client application 650 (e.g., associated with a user and/or a user device 640) and servers 610, which may be examples of the corresponding devices or systems as described herein with respect to FIGS. 1 and 2 (e.g., user device 240 and servers 210 of FIG. 2). Although the following description describes the servers 610 as providing information to the client application 650, the client application 650 may receive the information from the client application 650, the user device, the custodial token platform, other devices associated with the user, etc. In the following description of the process flow 600, the operations between the client application 650 and the servers 610 may be transmitted in a different order than the example order shown, or the operations performed may be performed in different orders or at different times. Some operations may also be omitted from the process flow 600, and other operations may be added to the process flow 600.

The process flow 600 may include a subscription process 605 between a client application 650 and one or more servers 610 and/or the client application 650, the user device, other applications associated with the user device, the custodial token platform, etc. The subscription process 605 may involve the client application 650, at 615, transmitting a pending transaction query. The pending transaction query may include a request for an indication of pending transactions associated with the client application 650. For example, a user may create a transaction and after it is signed, the transaction may be added to a pending transactions queue. The pending transaction queue may be stored in local storage and may be managed by a Web3 transaction status provider. User interface components (e.g., UI components) may create a subscription for a transaction that has been added to the pending transactions queues in order to get real-time updates on the transaction status. The transaction may be confirmed on the blockchain and then removed from the queue. The UI component may create a subscription for the next transaction in the queue (if any) in a first-in-first-out (FIFO) manner, such that status for transactions that are created first will be updated and resolved first, even if subsequent transactions are confirmed earlier.

At 620, the client application 650 may transmit a pending transaction subscription to subscribe to any pending transactions found based on the query. At 625, the client application 650 may transmit a transaction state query, which may include a query into the statuses of the subscribed transactions. At 630, the client application 650 may receive a transaction state response in response to the transaction state query. The response may indicate the current statuses associated with the pending transactions. The client application 650 may subscribe to the pending transactions and the statuses of the pending transactions in order to provide updates to the user until the transactions are completed. As such, the client application 650 may create a transaction status query and subscription via at least 615, 620, and 625.

At 630, the client application 650 may receive a subscription heartbeat. The subscription heartbeat may facilitate the client application 650 checking the status of the pending transactions. For example, the servers 610 may support a service (e.g., a DeFi service) that periodically obtains information about transactions, and this service may relay the obtained information to the corresponding clients via responses (e.g., query responses). In some examples, the client application 650 may check the statuses based on the heartbeat duration (e.g., periods or intervals at which to check the status updates of the transactions). The DeFi service may update the query response when the states of subscribed transactions change. Accordingly, at 645, the client application 650 may receive update events when the state of the subscribed transactions changes. At 655, the client application of the user device may terminate subscription, for example, once a transaction has completed and/or based on user input (e.g., request to stop tracking or to stop notifications, request to cancel pending transaction, etc.). In some examples, a subscription may be terminated when upstream services associated with the client application 650 fail to provide accurate information on the transaction status, causing the status to remain in a pending state (e.g., transaction freezes) for greater than a threshold duration (e.g., 150 seconds). The client application 650 may request a status update for the next transaction in the pending transaction queue.

In some examples, at 660, when a wallet is not connected or does not exist, the client application 650, at the first position in a navigation banner of the client application, may display an indication to connect or to create a wallet associated with the client application. In some examples, the navigation banner may be positioned at a bottom portion of a user interface of the client application 650.

Once the wallet is connected, at 665, the client application of the user device 640 may display, in a navigation banner, at the first position in a navigation banner of the client application, an address indicator of a wallet address associated with the client application. The client application may be configured to navigate to a crypto token summary page after activation of the address indicator in the navigation banner. In some examples, the client application 650 may receive a user input that selects the address indicator. The client application 650 may display, after receiving the user input, the crypto token summary page that indicates a summary of crypto tokens associated with the wallet address.

At 670, the client application 650 may receive information that indicates that a message associated with the wallet address is submitted for broadcast via a blockchain network. Receiving the information may include receiving one or more inputs, by a user at the user interface, and the one or more inputs may be configured to request and/or confirm the transactions. In some examples, receiving information that indicates that the message includes receiving the information that indicates that non-custodial wallet address managed by a platform associated with the client application is sent a crypto token to the wallet address associated with the client application.

At 675, the client application 650 may subscribe, after receiving the information, to a data feed associated with the message, as discussed with respect to the subscription process 605. The data feed may be supported by one or more servers 610 associated with the client application 650. At 680, the client application 650 may display, after receiving the information and at the first position in the navigation banner, a pending indicator that indicates that the message is pending confirmation via the blockchain network. The client application 650 may be configured to navigate to a message information page after activation of the pending indicator in the navigation banner, and the pending indicator may replace the address indicator. The pending indicator may be displayed based on the message information received via the data feed.

In some examples, the client application 650 may receive, via a user interface component of the client application 650, user input requesting that the message be broadcast via the blockchain network. The pending indicator may be displayed in response to receiving the user input. In some examples, the message information page may include message details associated with multiple messages including the message. In some examples, the pending indicator may indicate a quantity of pending messages associated with a wallet supported by the client application. In some examples, the client application 650 may receive a user input that selects the pending indicator. The client application 650 may display, after receiving the user input, the message information page that indicates that the message is pending and comprises message details associated with the message. In this manner, using the subscription techniques described herein, user experience in performing a transaction may be improved, for example, by the user receiving live or real-time updates regarding the various statuses of the transaction.

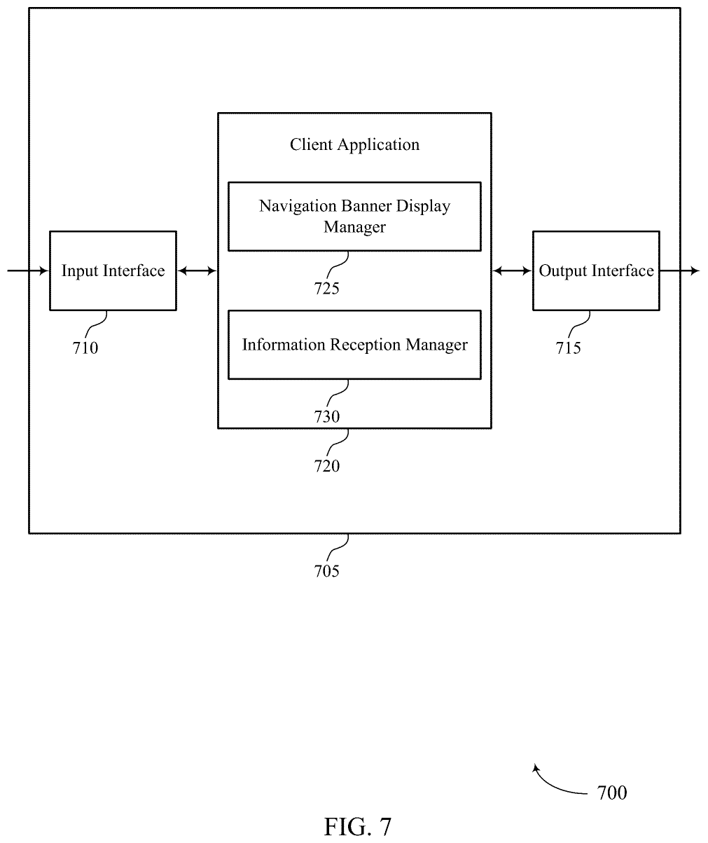

FIG. 7 shows a block diagram 700 of a device 705 that supports displaying message status for a blockchain message in accordance with aspects of the present disclosure. The device 705 may include an input interface 710, an output interface 715, and a client application 720. The device 705, or one or more components of the device 705 (e.g., the input interface 710, the output interface 715, and the client application 720), may include at least one processor, which may be coupled with at least one memory, to support the described techniques. Each of these components may communicate, directly or indirectly, with one another (e.g., via one or more buses, communications links, communications interfaces, or any combination thereof).

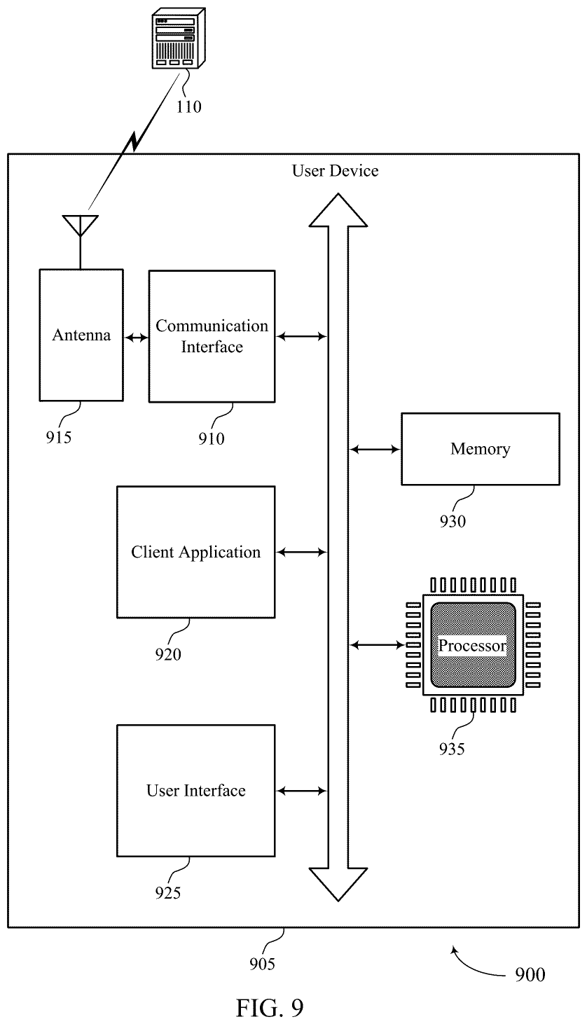

The input interface 710 may manage input signaling for the user device 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the user device 705 for processing. For example, the input interface 710 may transmit such corresponding signaling to the client application 720 to support displaying message status for a blockchain message. In some cases, the input interface 710 may be a component of a 910 as described with reference to FIG. 9.

The output interface 715 may manage output signaling for the user device 705. For example, the output interface 715 may receive signaling from other components of the user device 705, such as the client application 720, and may transmit such output signaling corresponding to (e.g., representative of or otherwise based on) such signaling to other systems or devices. In some cases, the output interface 715 may be a component of a user interface 925 as described with reference to FIG. 9.

For example, the client application 720 may include a navigation banner display manager 725 an information reception manager 730, or any combination thereof. In some examples, the client application 720, or various components thereof, may be configured to perform various operations (e.g., receiving, monitoring, transmitting) using or otherwise in cooperation with the input interface 710, the output interface 715, or both. For example, the client application 720 may receive information from the input interface 710, send information to the output interface 715, or be integrated in combination with the input interface 710, the output interface 715, or both to receive information, transmit information, or perform various other operations as described herein.

The client application 720 may support tracking message status in a client application in accordance with examples as disclosed herein. The navigation banner display manager 725 may be configured as or otherwise support a means for displaying, at a first position in a navigation banner of a client application, an address indicator of a wallet address associated with the client application, wherein the client application is configured to navigate to a crypto token summary page after activation of the address indicator in the navigation banner. The information reception manager 730 may be configured as or otherwise support a means for receiving, at the client application, information that indicates that a message associated with the wallet address is submitted for broadcast via a blockchain network. The navigation banner display manager 725 may be configured as or otherwise support a means for displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

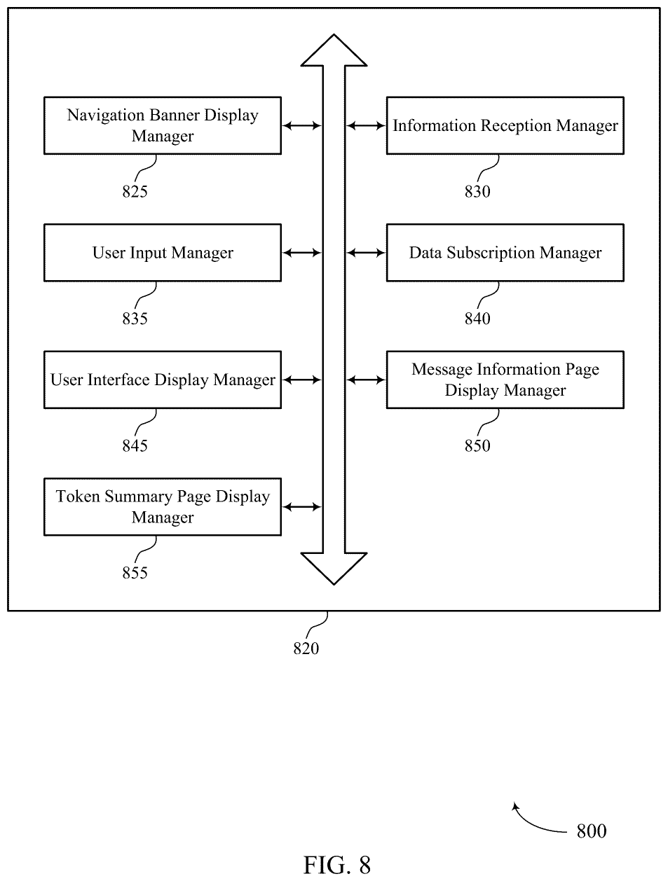

FIG. 8 shows a block diagram 800 of a client application 820 that supports displaying message status for a blockchain message in accordance with aspects of the present disclosure. The client application 820 may be an example of aspects of a client application 720 as described herein. The client application 820, or various components thereof, may be an example of means for performing various aspects of displaying message status for a blockchain message as described herein. For example, the client application 820 may include a navigation banner display manager 825, an information reception manager 830, a user input manager 835, a data subscription manager 840, a user interface display manager 845, a message information page display manager 850, a token summary page display manager 855, or any combination thereof. Each of these components may communicate, directly or indirectly, with one another (e.g., via one or more buses, communications links, communications interfaces, or any combination thereof).

The client application 820 may support tracking message status in a client application in accordance with examples as disclosed herein. The navigation banner display manager 825 may be configured as or otherwise support a means for displaying, at a first position in a navigation banner of a client application, an address indicator of a wallet address associated with the client application, wherein the client application is configured to navigate to a crypto token summary page after activation of the address indicator in the navigation banner. The information reception manager 830 may be configured as or otherwise support a means for receiving, at the client application, information that indicates that a message associated with the wallet address is submitted for broadcast via a blockchain network. In some examples, the navigation banner display manager 825 may be configured as or otherwise support a means for displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

In some examples, the user input manager 835 may be configured as or otherwise support a means for receiving, via a user interface component of the client application, user input requesting that the message be broadcast via the blockchain network, wherein the pending indicator is displayed in response to receiving the user input.

In some examples, the navigation banner display manager 825 may be configured as or otherwise support a means for displaying, in the navigation banner of the client application, second information indicating that a wallet associated with the client application is connected to a second application supported by the blockchain network.

In some examples, the navigation banner display manager 825 may be configured as or otherwise support a means for displaying, at the first position in the navigation banner of the client application, an indication to connect or to create a wallet associated with the client application.

In some examples, the data subscription manager 840 may be configured as or otherwise support a means for subscribing, after receiving the information, to a data feed associated with the message, wherein the data feed is supported by one or more servers associated with the client application and wherein the pending indicator is displayed based on message information received via the data feed.

In some examples, the user interface display manager 845 may be configured as or otherwise support a means for displaying, via a user interface component of the client application, second information that indicates a result of the message being broadcast via the blockchain network, wherein the result is failure or completion.

In some examples, the user input manager 835 may be configured as or otherwise support a means for receiving, at the client application, a user input that selects the pending indicator. In some examples, the message information page display manager 850 may be configured as or otherwise support a means for displaying, after receiving the user input, the message information page that indicates that the message is pending and comprises message details associated with the message.

In some examples, the user input manager 835 may be configured as or otherwise support a means for receiving, at the client application, a user input that selects the address indicator. In some examples, the token summary page display manager 855 may be configured as or otherwise support a means for displaying, after receiving the user input, the crypto token summary page that indicates a summary of crypto tokens associated with the wallet address.

In some examples, the message information page comprises message details associated with a plurality of messages including the message.

In some examples, the pending indicator indicates a quantity of pending messages associated with a wallet supported by the client application.

In some examples, to support receiving the information, the information reception manager 830 may be configured as or otherwise support a means for receiving the information that indicates that non-custodial wallet address managed by a platform associated with the client application sent a crypto token to the wallet address associated with the client application.

In some examples, the navigation banner is positioned at a bottom portion of a user interface of the client application.

FIG. 9 shows a diagram of a system 900 including a device 905 that supports displaying message status for a blockchain message in accordance with aspects of the present disclosure. The device 905 may be an example of or include the components of a device 705 as described herein. The device 905 may include components for bi-directional voice and data communications including components for transmitting and receiving communications, such as a client application 920, a communication interface 910, an antenna 915, a user interface 925, at least one memory 930, and at least one processor 935. Each of these components may communicate, directly or indirectly, with one another (e.g., via one or more buses, communications links, communications interfaces, or any combination thereof).

The communication interface 910 may manage input and output signals for the device 905 via the antenna 915. For example, the communication interface 910 may enable the user device 905 to exchange information (e.g., input information, output information, or both) with other systems or devices, such as custodial token platform 110 (e.g., supported by one or more servers), via one or more wired or wireless communication links. The communication interface 910 may also utilize or interact with antenna 915 to support communication with other systems or devices. In some cases, the communication interface 910 may represent a physical connection or port to an external peripheral, such as a hardware wallet device. In some cases, the communication interface 910 may utilize an operating system such as iOS®, ANDROID®, MS-DOS®, MS-WINDOWS®, OS/2®, UNIX®, LINUX®, or another known operating system. The communication interface 910 may be implemented as part of the processor 935.

In some cases, the device 905 may include a single antenna 915. However, in some other cases, the device 905 may have more than one antenna 915, which may be capable of concurrently transmitting or receiving multiple wireless transmissions. The communication interface 910 may communicate bi-directionally, via the one or more antennas 915, wired, or wireless links as described herein. For example, the communication interface 910 may represent a wireless transceiver and may communicate bi-directionally with another wireless transceiver. The communication interface 910 may also include a modem to modulate the packets, to provide the modulated packets to one or more antennas 915 for transmission, and to demodulate packets received from the one or more antennas 915.

The user interface 925 may represent a keyboard, a mouse, a touchscreen, a microphone, or a similar device or component. In some cases, a user may interact with the user interface 925. In other cases, the user interface 925 may operate automatically without user interaction. The user interface 925 may display or output information such as information received from other systems or devices or information to be transmitted to other systems or devices.

The memory 930 may include RAM and ROM. The memory 930 may store computer-readable, computer-executable software including instructions that, when executed, cause at least one processor 935 to perform various functions described herein. In some cases, the memory 930 may contain, among other things, a BIOS which may control basic hardware or software operation such as the interaction with peripheral components or devices. The memory 930 may be an example of a single memory or multiple memories. For example, the user device 905 may include one or more memories 930.

The processor 935 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 935 may be configured to operate a memory array using a memory controller. In other cases, a memory controller may be integrated into the processor 935. The processor 935 may be configured to execute computer-readable instructions stored in at least one memory 930 to perform various functions (e.g., functions or tasks supporting a method and system for displaying message status for a blockchain message). Though a single processor 935 is depicted in the example of FIG. 9, it is to be understood that the user device 905 may include any quantity of one or more of processors 935 and that a group of processors 935 may collectively perform one or more functions ascribed herein to a processor, such as the processor 935. The processor 935 may be an example of a single processor or multiple processors. For example, the device 905 may include one or more processors 935.

The client application 920 may support tracking message status in a client application in accordance with examples as disclosed herein. For example, the client application 920 may be configured as or otherwise support a means for displaying, at a first position in a navigation banner of a client application, an address indicator of a wallet address associated with the client application, wherein the client application is configured to navigate to a crypto token summary page after activation of the address indicator in the navigation banner. The client application 920 may be configured as or otherwise support a means for receiving, at the client application, information that indicates that a message associated with the wallet address is submitted for broadcast via a blockchain network. The client application 920 may be configured as or otherwise support a means for displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

By including or configuring the client application 920 in accordance with examples as described herein, the device 905 may support techniques for subscribing to data for tracking a transaction status, including status of at least submitted, pending or in progress, and completed, to facilitate an improved user experience for viewing the status of the transaction.

The client application 920 may include an application (e.g., “app”), program, software, extension, or other component which is configured to facilitate communications with a custodial token platform 110 on a server, one or more nodes of a blockchain network 105, other user devices 905, and other devices or systems. For example, the client application 920 may be an application executable on the user device 905, and the client application 920 may be configured to receive data from a custodial token platform 110, transmit data to the custodial token platform 110, process such data, and cause presentation of such data to a user via a user interface 925. The client application 920 may be an example of a wallet application, a wallet device, or both, and may be associated with a wallet address and may access or use a private key to sign messages to facilitate transfer of crypto tokens, messages, transactions, or the like via a blockchain distributed data store.

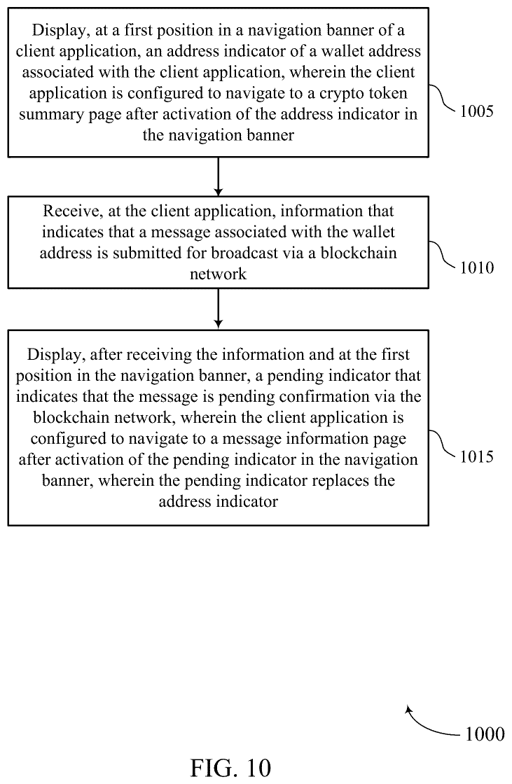

FIG. 10 shows a flowchart illustrating a method 1000 that supports displaying message status for a blockchain message in accordance with aspects of the present disclosure. The operations of the method 1000 may be implemented by a user device or its components as described herein. For example, the operations of the method 1000 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1005, the method may include displaying, at a first position in a navigation banner of a client application, an address indicator of a wallet address associated with the client application, wherein the client application is configured to navigate to a crypto token summary page after activation of the address indicator in the navigation banner. The operations of block 1005 may be performed in accordance with examples as disclosed herein. In some examples, aspects of the operations of 1005 may be performed by a navigation banner display manager 825 as described with reference to FIG. 8.

At 1010, the method may include receiving, at the client application, information that indicates that a message associated with the wallet address is submitted for broadcast via a blockchain network. The operations of block 1010 may be performed in accordance with examples as disclosed herein. In some examples, aspects of the operations of 1010 may be performed by an information reception manager 830 as described with reference to FIG. 8.

At 1015, the method may include displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator. The operations of block 1015 may be performed in accordance with examples as disclosed herein. In some examples, aspects of the operations of 1015 may be performed by a navigation banner display manager 825 as described with reference to FIG. 8.

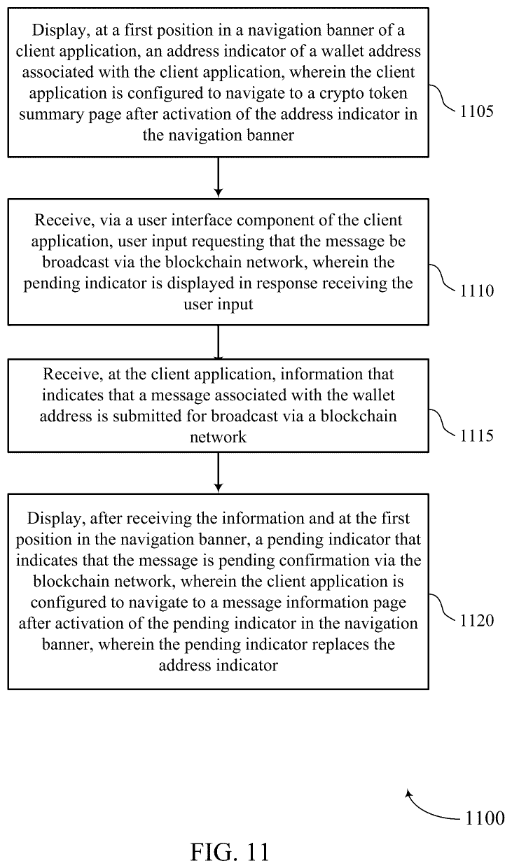

FIG. 11 shows a flowchart illustrating a method 1100 that supports displaying message status for a blockchain message in accordance with aspects of the present disclosure. The operations of the method 1100 may be implemented by a user device or its components as described herein. For example, the operations of the method 1100 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1105, the method may include displaying, at a first position in a navigation banner of a client application, an address indicator of a wallet address associated with the client application, wherein the client application is configured to navigate to a crypto token summary page after activation of the address indicator in the navigation banner. The operations of block 1105 may be performed in accordance with examples as disclosed herein. In some examples, aspects of the operations of 1105 may be performed by a navigation banner display manager 825 as described with reference to FIG. 8.

At 1110, the method may include receiving, via a user interface component of the client application, user input requesting that the message be broadcast via the blockchain network, wherein the pending indicator is displayed in response to receiving the user input. The operations of block 1110 may be performed in accordance with examples as disclosed herein. In some examples, aspects of the operations of 1110 may be performed by a user input manager 835 as described with reference to FIG. 8.

At 1115, the method may include receiving, at the client application, information that indicates that a message associated with the wallet address is submitted for broadcast via a blockchain network. The operations of block 1115 may be performed in accordance with examples as disclosed herein. In some examples, aspects of the operations of 1115 may be performed by an information reception manager 830 as described with reference to FIG. 8.

At 1120, the method may include displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator. The operations of block 1120 may be performed in accordance with examples as disclosed herein. In some examples, aspects of the operations of 1120 may be performed by a navigation banner display manager 825 as described with reference to FIG. 8.

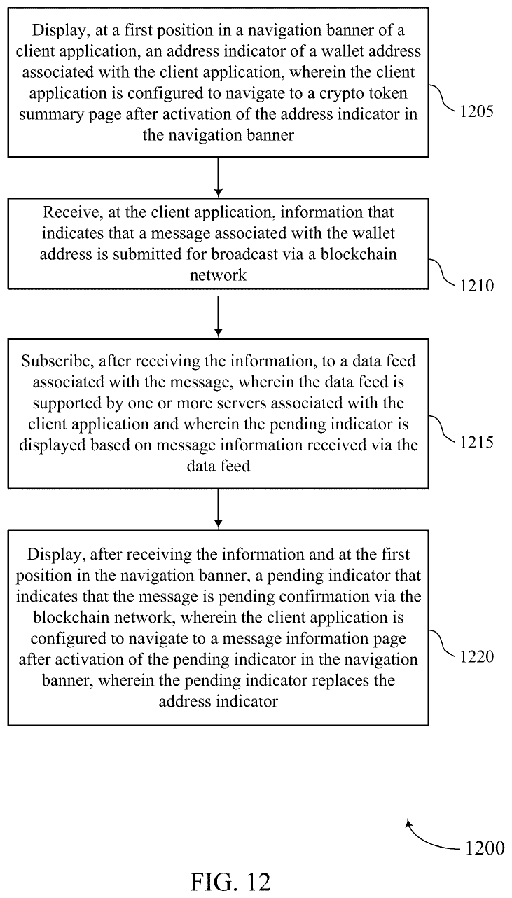

FIG. 12 shows a flowchart illustrating a method 1200 that supports displaying message status for a blockchain message in accordance with aspects of the present disclosure. The operations of the method 1200 may be implemented by a user device or its components as described herein. For example, the operations of the method 1200 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1205, the method may include displaying, at a first position in a navigation banner of a client application, an address indicator of a wallet address associated with the client application, wherein the client application is configured to navigate to a crypto token summary page after activation of the address indicator in the navigation banner. The operations of block 1205 may be performed in accordance with examples as disclosed herein. In some examples, aspects of the operations of 1205 may be performed by a navigation banner display manager 825 as described with reference to FIG. 8.

At 1210, the method may include receiving, at the client application, information that indicates that a message associated with the wallet address is submitted for broadcast via a blockchain network. The operations of block 1210 may be performed in accordance with examples as disclosed herein. In some examples, aspects of the operations of 1210 may be performed by an information reception manager 830 as described with reference to FIG. 8.

At 1215, the method may include subscribing, after receiving the information, to a data feed associated with the message, wherein the data feed is supported by one or more servers associated with the client application and wherein the pending indicator is displayed based on message information received via the data feed. The operations of block 1215 may be performed in accordance with examples as disclosed herein. In some examples, aspects of the operations of 1215 may be performed by a data subscription manager 840 as described with reference to FIG. 8.

At 1220, the method may include displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator. The operations of block 1220 may be performed in accordance with examples as disclosed herein. In some examples, aspects of the operations of 1220 may be performed by a navigation banner display manager 825 as described with reference to FIG. 8.

A method for tracking message status in a client application by an apparatus is described. The method may include displaying, at a first position in a navigation banner of a client application, an address indicator of a wallet address associated with the client application, wherein the client application is configured to navigate to a crypto token summary page after activation of the address indicator in the navigation banner, receiving, at the client application, information that indicates that a message associated with the wallet address is submitted for broadcast via a blockchain network, and displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

An apparatus for tracking message status in a client application is described. The apparatus may include one or more memories storing processor executable code, and one or more processors coupled with the one or more memories. The one or more processors may individually or collectively operable to execute the code to cause the apparatus to display, at a first position in a navigation banner of a client application, an address indicator of a wallet address associated with the client application, wherein the client application is configured to navigate to a crypto token summary page after activation of the address indicator in the navigation banner, receive, at the client application, information that indicates that a message associated with the wallet address is submitted for broadcast via a blockchain network, and display, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

Another apparatus for tracking message status in a client application is described. The apparatus may include means for displaying, at a first position in a navigation banner of a client application, an address indicator of a wallet address associated with the client application, wherein the client application is configured to navigate to a crypto token summary page after activation of the address indicator in the navigation banner, means for receiving, at the client application, information that indicates that a message associated with the wallet address is submitted for broadcast via a blockchain network, and means for displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

A non-transitory computer-readable medium storing code for tracking message status in a client application is described. The code may include instructions executable by a processor to display, at a first position in a navigation banner of a client application, an address indicator of a wallet address associated with the client application, wherein the client application is configured to navigate to a crypto token summary page after activation of the address indicator in the navigation banner, receive, at the client application, information that indicates that a message associated with the wallet address is submitted for broadcast via a blockchain network, and display, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

Some examples of the method, apparatus, and non-transitory computer-readable medium described herein may further include operations, features, means, or instructions for receiving, via a user interface component of the client application, user input requesting that the message be broadcast via the blockchain network, wherein the pending indicator may be displayed in response receiving the user input.

Some examples of the method, apparatus, and non-transitory computer-readable medium described herein may further include operations, features, means, or instructions for displaying, in the navigation banner of the client application, second information indicating that a wallet associated the client application may be connected to a second application supported by the blockchain network.

Some examples of the method, apparatus, and non-transitory computer-readable medium described herein may further include operations, features, means, or instructions for displaying, at the first position in the navigation banner of the client application, an indication to connect or to create a wallet associated with the client application.

Some examples of the method, apparatus, and non-transitory computer-readable medium described herein may further include operations, features, means, or instructions for subscribing, after receiving the information, to a data feed associated with the message, wherein the data feed may be supported by one or more servers associated with the client application and wherein the pending indicator may be displayed based on message information received via the data feed.

Some examples of the method, apparatus, and non-transitory computer-readable medium described herein may further include operations, features, means, or instructions for displaying, via a user interface component of the client application, second information that indicates a result of the message being broadcast via the blockchain network, wherein the result may be failure or completion.

Some examples of the method, apparatus, and non-transitory computer-readable medium described herein may further include operations, features, means, or instructions for receiving, at the client application, a user input that selects the pending indicator and displaying, after receiving the user input, the message information page that indicates that the message may be pending and comprises message details associated the message.

Some examples of the method, apparatus, and non-transitory computer-readable medium described herein may further include operations, features, means, or instructions for receiving, at the client application, a user input that selects the address indicator and displaying, after receiving the user input, the crypto token summary page that indicates a summary of crypto tokens associated with the wallet address.

In some examples of the method, apparatus, and non-transitory computer-readable medium described herein, the message information page comprises message details associated with a plurality of messages including the message.

In some examples of the method, apparatus, and non-transitory computer-readable medium described herein, the pending indicator indicates a quantity of pending messages associated with a wallet supported by the client application.

In some examples of the method, apparatus, and non-transitory computer-readable medium described herein, receiving the information may include operations, features, means, or instructions for receiving the information that indicates that non-custodial wallet address managed by a platform associated with the client application sent a crypto token to the wallet address associated with the client application.

In some examples of the method, apparatus, and non-transitory computer-readable medium described herein, the navigation banner may be positioned at a bottom portion of a user interface of the client application.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for tracking message status in a client application, comprising:
displaying, at a first position in a navigation banner of a client application, an address indicator of a wallet address associated with the client application, wherein the client application is configured to navigate to a crypto token summary page after activation of the address indicator in the navigation banner;
receiving, at the client application, information that indicates that a message associated with the wallet address is submitted for broadcast via a blockchain network; and
displaying, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

2. The method of claim 1, further comprising:
receiving, via a user interface component of the client application, user input requesting that the message be broadcast via the blockchain network, wherein the pending indicator is displayed in response to receiving the user input.

3. The method of claim 1, further comprising:
displaying, in the navigation banner of the client application, second information indicating that a wallet associated with the client application is connected to a second application supported by the blockchain network.

4. The method of claim 1, further comprising:
displaying, at the first position in the navigation banner of the client application, an indication to connect or to create a wallet associated with the client application.

5. The method of claim 1, further comprising:
subscribing, after receiving the information, to a data feed associated with the message, wherein the data feed is supported by one or more servers associated with the client application and wherein the pending indicator is displayed based on message information received via the data feed.

6. The method of claim 1, further comprising:
displaying, via a user interface component of the client application, second information that indicates a result of the message being broadcast via the blockchain network, wherein the result is failure or completion.

7. The method of claim 1, further comprising:
receiving, at the client application, a user input that selects the pending indicator; and
displaying, after receiving the user input, the message information page that indicates that the message is pending and comprises message details associated with the message.

8. The method of claim 1, further comprising:
receiving, at the client application, a user input that selects the address indicator; and
displaying, after receiving the user input, the crypto token summary page that indicates a summary of crypto tokens associated with the wallet address.

9. The method of claim 1, wherein the message information page comprises message details associated with a plurality of messages including the message.

10. The method of claim 1, wherein the pending indicator indicates a quantity of pending messages associated with a wallet supported by the client application.

11. The method of claim 1, wherein receiving the information comprises:
receiving the information that indicates that non-custodial wallet address managed by a platform associated with the client application sent a crypto token to the wallet address associated with the client application.

12. The method of claim 1, wherein the navigation banner is positioned at a bottom portion of a user interface of the client application.

13. An apparatus for tracking message status in a client application, comprising:
one or more memories storing processor-executable code; and
one or more processors coupled with the one or more memories and individually or collectively operable to execute the code to cause the apparatus to:
display, at a first position in a navigation banner of a client application, an address indicator of a wallet address associated with the client application, wherein the client application is configured to navigate to a crypto token summary page after activation of the address indicator in the navigation banner;
receive, at the client application, information that indicates that a message associated with the wallet address is submitted for broadcast via a blockchain network; and
display, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

14. The apparatus of claim 13, wherein the one or more processors are individually or collectively further operable to execute the code to cause the apparatus to:
receive, via a user interface component of the client application, user input requesting that the message be broadcast via the blockchain network, wherein the pending indicator is displayed in response to receiving the user input.

15. The apparatus of claim 13, wherein the one or more processors are individually or collectively further operable to execute the code to cause the apparatus to:
display, in the navigation banner of the client application, second information indicating that a wallet associated with the client application is connected to a second application supported by the blockchain network.

16. The apparatus of claim 13, wherein the one or more processors are individually or collectively further operable to execute the code to cause the apparatus to:
display, at the first position in the navigation banner of the client application, an indication to connect or to create a wallet associated with the client application.

17. A non-transitory computer-readable medium storing code for tracking message status in a client application, the code comprising instructions executable by one or more processors to:
display, at a first position in a navigation banner of a client application, an address indicator of a wallet address associated with the client application, wherein the client application is configured to navigate to a crypto token summary page after activation of the address indicator in the navigation banner;
receive, at the client application, information that indicates that a message associated with the wallet address is submitted for broadcast via a blockchain network; and
display, after receiving the information and at the first position in the navigation banner, a pending indicator that indicates that the message is pending confirmation via the blockchain network, wherein the client application is configured to navigate to a message information page after activation of the pending indicator in the navigation banner, wherein the pending indicator replaces the address indicator.

18. The non-transitory computer-readable medium of claim 17, wherein the instructions are further executable by the one or more processors to:
subscribe, after receiving the information, to a data feed associated with the message, wherein the data feed is supported by one or more servers associated with the client application and wherein the pending indicator is displayed based on message information received via the data feed.

19. The non-transitory computer-readable medium of claim 17, wherein the instructions are further executable by the one or more processors to:
display, via a user interface component of the client application, second information that indicates a result of the message being broadcast via the blockchain network, wherein the result is failure or completion.

20. The non-transitory computer-readable medium of claim 17, wherein the instructions are further executable by the one or more processors to:
receive, at the client application, a user input that selects the pending indicator; and
display, after receiving the user input, the message information page that indicates that the message is pending and comprises message details associated with the message.
